(19) United States
(12) Patent Application Publication
(10) Pub. No.: US 2022/0231537 A1
(43) Pub. Date: Jul. 21, 2022

(54) CONVERSION DEVICE, CONVERSION SYSTEM, SWITCHING DEVICE, VEHICLE INCLUDING THE SAME, AND CONTROL METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Masayoshi Hirota, Yokkaichi-shi, Mie (JP); Takafumi Kawakami, Yokkaichi-shi, Mie (JP); Yasushi Tamura, Yokkaichi-shi, Mie (JP)

(21) Appl. No.: 17/610,304

(22) PCT Filed: May 10, 2019
(86) PCT No.: PCT/JP2019/018790

§ 371 Date: Nov. 10, 2021

(51) Int. Cl. H02J 11/00; H02J 7/14; H02J 7/16

(52) U.S. Cl. CPC H02J 11/00; H02J 7/16; H02J 7/1423

(57) ABSTRACT

A conversion device is a conversion device that converts power supplied from a power supply device including a plurality of battery units, and includes a plurality of power conversion units. Each of the plurality of power conversion units is connected to the plurality of battery units such that a voltage within a range of a breakdown voltage of the power conversion unit is input.

### CROSS-REFERENCE TO RELATED APPLICATIONS

This application is the U.S. national stage of PCT/JP2019/018790 filed on May 10, 2019, the contents of which are incorporated herein.

### TECHNICAL FIELD

The present disclosure relates to a conversion device, a conversion system, a switching device, a vehicle including the same, and a control method.

### BACKGROUND

Increasing travel ranges and shortening battery charging times are issues in electric automobiles. In light of such issues, both battery capacities and battery voltages are expected to increase (i.e., higher voltages) in the future.

Higher battery voltages are expected to improve fast charging output. However, as a battery voltage increases, devices connected to the battery (e.g., a DC/DC converter or the like) must have higher breakdown voltages. JP 2018-85790A, indicated below, proposes a technique for shortening charging time and avoiding an increase in the breakdown voltage of devices by switching the connections of a plurality of batteries in an electric automobile to a series connection when charging and to a parallel connection when traveling.

With the technique disclosed in JP 2018-85790A, as described above, the plurality of batteries are put into a parallel connection when the vehicle is traveling in order to avoid increasing the breakdown voltage of the devices connected to the batteries. There is thus a problem in that the vehicle cannot travel while the batteries are in a series-connected state, i.e., a high-voltage state. For the vehicle to travel with the batteries in a series-connected state, it is necessary to use high-breakdown voltage devices which can handle the voltage (high voltage) occurring when the devices connected to the batteries are in a series connection. However, using such high-breakdown voltage devices is problematic in that the devices installed in the electric automobile increase in size. Additionally, in electric automobiles, the motor output is proportional to the system voltage (battery voltage), and thus the configuration disclosed in JP 2018-85790A is problematic in that there is a limit to how much the motor output can be increased.

Accordingly, it is an object of the present disclosure to provide a conversion device, a conversion system, a switching device, a vehicle including the same, and a control method that enable driving without providing devices for high voltages when a plurality of batteries are connected in series and output a high voltage.

### SUMMARY

A conversion device according to an aspect of the present disclosure is a conversion device that converts power supplied from a power supply device including a plurality of battery units, and includes a plurality of power conversion units, wherein each of the plurality of power conversion units is connected to the plurality of battery units such that a voltage within a range of a breakdown voltage of the power conversion units is input.

A conversion system according to another aspect of the present disclosure includes a power supply device including a plurality of battery units, and the above-described conversion device, the conversion device converting power supplied from the power supply device.

A switching device according to another aspect of the present disclosure is a switching device that, in a system including a power supply device having a plurality of battery units and a plurality of power conversion devices that convert power supplied from the plurality of battery units, switches a connection state of the plurality of power conversion devices. Each of the plurality of power conversion units is connected to the plurality of battery units such that a voltage within a range of a breakdown voltage of the power conversion devices is input. The switching device includes a plurality of switches that, by switching, in accordance with a predetermined condition being satisfied, a connection state of the plurality of battery units to one of a series connection state in which the battery units are connected to each other in series and a parallel connection state in which the battery units are connected to each other in parallel, switch a connection state of the plurality of power conversion devices to one of the series connection state and the parallel connection state.

A vehicle according to another aspect of the present disclosure includes the above-described conversion system, and a load to which power converted by the conversion system is supplied.

A control method according to another aspect of the present disclosure is a control method that, in a system including a power supply device having a plurality of battery units and a plurality of power conversion devices that convert power supplied from the plurality of battery units, controls switching of a connection state of the plurality of power conversion devices. Each of the plurality of power conversion devices is connected to the plurality of battery units such that a voltage within a range of a breakdown voltage of the power conversion devices is input. The control method includes a step of switching, in accordance with a predetermined condition being satisfied, a connection state of the plurality of battery units to one of a series connection state in which the battery units are connected to each other in series and a parallel connection state in which the battery units are connected to each other in parallel, to switch a connection state of the plurality of power conversion devices to one of the series connection state and the parallel connection state.

### Advantageous Effects of Invention

According to the present disclosure, it is possible to drive without providing devices for high voltages when a plurality of batteries are connected in series and output a high voltage. Furthermore, in a vehicle, the motor output can be increased when the vehicle is traveling.

### BRIEF DESCRIPTION OF DRAWINGS

FIG. 1 is a block diagram illustrating the configuration of a power conversion system according to an embodiment of the present disclosure.

FIG. 2 is a schematic diagram illustrating a vehicle according to an embodiment of the present disclosure.

FIG. 3 is a circuit diagram illustrating a detailed example of the configuration of a DC/DC converter.

FIG. 4 is a block diagram illustrating a state in which a plurality of battery units illustrated in FIG. 1 are connected in series.

FIG. 5 is a block diagram illustrating a state in which a plurality of battery units illustrated in FIG. 1 are connected in parallel.

FIG. 6 is a block diagram illustrating the configuration of a power conversion system according to a first variation.

FIG. 7 is a block diagram illustrating the configuration of a power conversion system according to a second variation.

FIG. 8 is a block diagram illustrating the configuration of a power conversion system according to a third variation.

FIG. 9 is a block diagram illustrating the configuration of a power conversion system according to a fourth variation.

FIG. 10 is a block diagram illustrating a state in which a plurality of battery units illustrated in FIG. 9 are connected in series.

FIG. 11 is a block diagram illustrating a state in which a plurality of battery units illustrated in FIG. 9 are connected in parallel.

### DETAILED DESCRIPTION OF PREFERRED EMBODIMENTS

First, the content of embodiments of the present disclosure will be listed and described. The embodiments described hereinafter may be at least partially combined as desired.

A conversion device according to a first aspect of the present disclosure is a conversion device that converts power supplied from a power supply device including a plurality of battery units, and includes a plurality of power conversion units, wherein each of the plurality of power conversion units is connected to the plurality of battery units such that a voltage within a range of a breakdown voltage of the power conversion units is input. Through this, it is possible to drive without providing devices for high voltages when a plurality of battery units output a high voltage. In other words, high-voltage output from a power supply device can be handled using a conventional conversion device (e.g., a DC/DC converter).

Preferably, a connection state of each of the battery units in the plurality of battery units is switched between a series connection state and a parallel connection state, and the plurality of power conversion units can be switched to one of a series connection state, in which the power conversion units are connected to each other in series, and a parallel connection state, in which the power conversion units are connected to each other in parallel, in accordance with the connection state of each of the battery units in the plurality of battery units. Through this, when the plurality of battery units are connected in series and output a high voltage, the plurality of power conversion units also enter the series connection state, and a voltage obtained by dividing the high voltage is input to each of the power conversion units. Accordingly, a conversion device capable of driving without including devices for high voltages can be achieved with ease. Furthermore, even if one conversion device has failed, this configuration makes it possible for the function of voltage conversion to be maintained by the remaining conversion devices by changing the connection state of the plurality of battery units. This therefore also makes it possible to provide a system having redundancy.

More preferably, each of the plurality of battery units has an output rating lower than the breakdown voltage of any of the plurality of power conversion units, and each of the plurality of power conversion units is connected to corresponding ones of the plurality of battery units. This makes it possible to prevent a voltage exceeding the breakdown voltage of the power conversion unit from being input to the power conversion unit.

Further preferably, the plurality of power conversion units include a step-down power conversion unit configured to step down and output the power supplied from the battery unit. Through this, the power conversion unit can step down and output the input voltage.

Preferably, the conversion device further includes a switching device configured to switch the connection states of the plurality of battery units. Through this, the plurality of battery units can be switched to an appropriate connection state in accordance with the states of the battery units. For example, when the output voltage of the battery units has dropped, the plurality of battery units can be connected in series, which makes it possible to avoid a drop in the output voltage from the power supply device.

Preferably, the conversion device further includes a control unit configured to control the switching device. The switching device is configured to switch the connection state of each of the plurality of battery units between the series connection state and the parallel connection state, and switch the connection state of the plurality of power conversion units with respect to the plurality of battery units. When controlling the switching device to switch the connection state of each of the plurality of battery units to the series connection state, the control unit can cause the switching device to perform an operation of switching the connection state of the plurality of power conversion units such that a voltage based on a voltage across both ends of at least one of the battery units among the plurality of battery units is applied to at least one of the plurality of power conversion units. Through this, the voltage across both ends of all the plurality of battery units can be prevented from being applied to any one of the power conversion units when the plurality of battery units are in the series connection state, while making it possible to switch the plurality of battery units between the series connection state and the parallel connection state. In other words, a situation in which the voltage across both ends of all the plurality of battery units put in the series connection state is applied to a power conversion unit while that voltage exceeds the breakdown voltage of the power conversion unit can be prevented. The conversion device can then be caused to operate such that a voltage based on the voltage across both ends of at least one of the battery units is applied to any one of the power conversion units.

Preferably, the conversion device further includes a control unit configured to control the switching device. The switching device is configured to switch the connection state of each of the plurality of battery units between the series connection state and the parallel connection state, switch the connection state of each of the plurality of power conversion units between the series connection state and the parallel connection state, and switch the connection state of the plurality of power conversion units with respect to the plurality of battery units. When controlling the switching device to switch the connection state of each of the plurality of battery units to the series connection state, the control unit can cause the switching device to perform an operation of switching the connection state of each of the plurality of power conversion units to the series connection state, and switching the connection state of the plurality of power conversion units such that a voltage based on a voltage across both ends of the plurality of battery units put into the series connection state is applied to both ends of the plurality of power conversion units put into the series connection state. Through this, the voltage across both ends of all the plurality of battery units can be prevented from being applied only to any one of the power conversion units when the plurality of battery units are in the series connection state, while making it possible to switch the plurality of battery units between the series connection state and the parallel connection state. In other words, a situation in which the voltage across both ends of all the plurality of battery units put in the series connection state is applied to a power conversion unit while that voltage exceeds the breakdown voltage of the power conversion unit can be prevented. The conversion device can then be caused to operate such that a voltage obtained by dividing the voltage across both ends of all the plurality of battery units put into the series connection state is applied to each of the plurality of power conversion units.

Preferably, when controlling the switching device to switch the connection state of each of the plurality of battery units to the parallel connection state, the control unit can cause the switching device to perform an operation of switching the connection state of the plurality of power conversion units such that a voltage based on a voltage across both ends of the battery units put into the parallel connection state is applied to at least one of the plurality of power conversion units. This makes it possible for at least one of the power conversion units to operate well when the plurality of battery units are in the parallel connection state so as not to exceed the breakdown voltage of the power conversion units.

Preferably, when controlling the switching device to switch the connection state of each of the plurality of battery units to the parallel connection state, the control unit can cause the switching device to perform an operation of switching the connection state of the plurality of power conversion units such that a voltage based on a voltage across both ends of the battery units put into the parallel connection state is applied to both ends of the plurality of power conversion units put into the series connection state. Doing so further lowers the voltage applied to each of the power conversion units, which provides more sufficient measures with respect to breakdown voltage.

Preferably, the conversion device further includes a control unit configured to control the switching device, and a voltage detection unit configured to detect a voltage. The voltage detection unit detects an output voltage of the plurality of battery units when the plurality of battery units are in the series connection state. The switching device is configured to switch the connection state of each of the plurality of battery units between the series connection state and the parallel connection state, and switch the connection state of the plurality of power conversion units with respect to the plurality of battery units. The control unit can cause the switching device to perform an operation of switching the connection state of each of the plurality of battery units to the series connection state, and switching the connection state of the plurality of power conversion units such that a voltage based on the output voltage of the plurality of battery units put into the series connection state is applied to at least one of the plurality of power conversion units, under a condition that the output voltage detected by the voltage detection unit is less than or equal to a threshold.

By doing so, when a voltage based on the output voltage of the plurality of battery units put into the series connection state is applied to any one of the power conversion units and used, a voltage which is too high, and which greatly exceeds the threshold with respect to that power conversion unit, can be prevented from being applied.

A conversion system according to a second aspect of the present disclosure includes a power supply device including a plurality of battery units, and the above-described conversion device, the conversion device being configured to convert power supplied from the power supply device. Through this, it is possible to drive without providing devices for high voltages when a plurality of battery units are connected in series and output a high voltage.

More preferably, the conversion system further includes an inverter being configured to be supplied with the power from the power supply device, and a motor being configured to be supplied with power via the inverter. Through this, when a vehicle in which the conversion system is installed is traveling at a high speed, the plurality of battery units can be connected in series and supply the high voltage necessary for high-speed rotation of the motor.

A switching device according to a third aspect of the present disclosure is a switching device that, in a system including a power supply device having a plurality of battery units and a plurality of power conversion devices that convert power supplied from the plurality of battery units, switches a connection state of the plurality of power conversion devices. Each of the plurality of power conversion devices is connected to the plurality of battery units such that a voltage within a range of a breakdown voltage of the power conversion devices is input. The switching device includes a plurality of switches that, by switching, in accordance with a predetermined condition being satisfied, a connection state of the plurality of battery units to one of a series connection state in which the battery units are connected to each other in series and a parallel connection state in which the battery units are connected to each other in parallel, switch a connection state of the plurality of power conversion devices to one of the series connection state and the parallel connection state. Through this, it is possible to drive without providing devices for high voltages when a plurality of battery units are connected in series and output a high voltage.

Preferably, the switching device is installed, along with the system, in a vehicle, and the predetermined condition includes a condition pertaining to a travel condition. Through this, for example, when the vehicle is traveling at a high speed, the plurality of battery units can be connected in series and supply the high voltage necessary for high-speed rotation of the motor.

More preferably, at least one of the plurality of switches includes a semiconductor relay. This makes it possible to realize a switching device that has a long lifespan, can switch with high responsiveness, and does not act as a noise source.

A vehicle according to a fourth aspect of the present disclosure includes the above-described conversion system, and a load to which power converted by the conversion system is supplied. Through this, it is possible to drive without providing devices for high voltages when a plurality of battery units are connected in series and output a high voltage. If another device directly connected to the batteries (an air conditioners or the like) is connected to one of the plurality of battery units, when the plurality of battery units are connected in series, no high voltage is applied to the device, and there is therefore no need to make the device having high-voltage specifications.

A control method according to a fifth aspect of the present disclosure is a control method that, in a system including a power supply device having a plurality of battery units and a plurality of power conversion devices that convert power supplied from the plurality of battery units, controls switching of a connection state of the plurality of power conversion devices. Each of the plurality of power conversion devices is connected to the plurality of battery units such that a voltage within a range of a breakdown voltage of the power conversion devices is input. The control method includes a step of switching, in accordance with a predetermined condition being satisfied, a connection state of the plurality of battery units to one of a series connection state in which the battery units are connected to each other in series and a parallel connection state in which the battery units are connected to each other in parallel, to switch a connection state of the plurality of power conversion devices to one of the series connection state and the parallel connection state. Through this, it is possible to drive without providing devices for high voltages when a plurality of battery units are connected in series and output a high voltage.

In the following embodiments, identical reference numerals are assigned to identical components. The names and functions thereof are also the same. Accordingly, detailed descriptions thereof will not be repeated. Embodiment

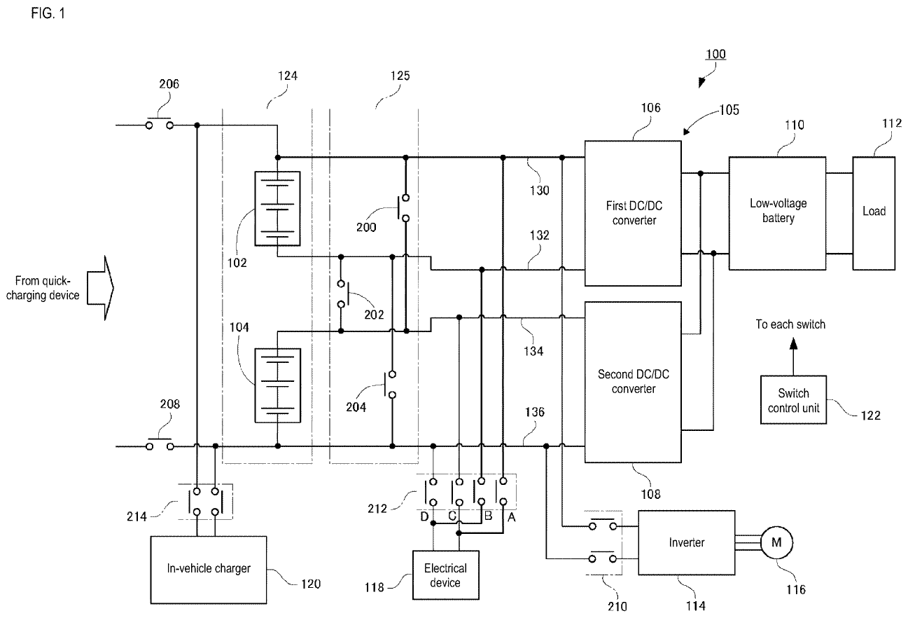

Referring to FIG. 1, a power conversion system 100 according to an embodiment of the present disclosure includes a battery unit 102, a battery unit 104, a conversion device 105, a first DC/DC converter 106, a second DC/DC converter 108, a low-voltage battery 110, a load 112, an inverter 114, a motor 116, an electrical device 118, an in-vehicle charger 120, switches 200 to 208, and switch sections 210 to 214.

The battery unit 102 and the battery unit 104 are units constituted by storage batteries that can be charged and discharged. The battery unit 102 and the battery unit 104 constitute a high-voltage battery section 124, which is an example of a power supply device. The battery unit 102 and the battery unit 104 are, for example, battery units having 400 V specifications (rated at 400 V for charging voltage and output voltage) and are connected to a switching device 125 constituted by the switches 200 to 204. The switches 200 to 204 are semiconductor relays, for example. Semiconductor relays have long lifespans, can be switched with good responsiveness, do not generate high-frequency noise during switching and therefore do not act as noise source, and are therefore preferred as switches. Note, however, that the switches 200 to 204 may be electromagnetic relays. One terminal (a terminal of the same polarity (positive)) of each of the battery unit 102 and the battery unit 104 is connected to the other via the switch 200. Another terminal (a terminal of the polarity opposite to the one terminal (negative)) of each of the battery unit 102 and the battery unit 104 is connected to the other via the switch 204. Furthermore, the other terminal of the battery unit 102 and the one terminal of the battery unit 104 (terminals of different polarities) are connected to each other via the switch 202. Note that the high-voltage battery section 124 may be configured to include the switching device 125. Additionally, each of the battery unit 102 and the battery unit 104 is not limited to a plurality of batteries in a unit, but may be a single ordinary battery.

The conversion device 105 is constituted by at least the first DC/DC converter 106 and the second DC/DC converter 108. The first DC/DC converter 106 and the second DC/DC converter 108 are step-down DC/DC converters that convert a high voltage supplied from the high-voltage battery section 124 to a low voltage (e.g., 12 V). The first DC/DC converter 106 and the second DC/DC converter 108 supply the converted voltage to the low-voltage battery 110. The first DC/DC converter 106 and the second DC/DC converter 108 are input with a voltage within the range of the converters' respective breakdown voltages. Note that even if the switches 200 to 204 are switched as described later, the first DC/DC converter 106 and the second DC/DC converter 108 are input with a voltage within the range of the converters' respective breakdown voltages. The first DC/DC converter 106 and the second DC/DC converter 108, for example, have an input voltage specification of 400 V. A wire 130 and a wire 132 connected to an input terminal of the first DC/DC converter 106 are connected to one terminal of the battery unit 102 and the other terminal of the battery unit 102, respectively. A wire 134 and a wire 136 connected to an input terminal of the second DC/DC converter 108 are connected to one terminal of the battery unit 104 and the other terminal of the battery unit 104, respectively.

Output terminals of the first DC/DC converter 106 and the second DC/DC converter 108 are connected in parallel, and are connected to an input terminal of the low-voltage battery 110. An output terminal of the low-voltage battery 110 is connected to the load 112. The low-voltage battery 110 is charged by voltage input from the first DC/DC converter 106 and the second DC/DC converter 108, and supplies power to the load 112.

Input terminals of the inverter 114 are connected to the wire 130 and the wire 136 via the switches of the switch section 210. An output terminal of the inverter 114 is connected to an input terminal of the motor 116. The motor 116 is an electrical drive device such as a main engine system motor or the like. The inverter 114 supplies power for driving the motor 116 to the motor 116. Note that the inverter 114 may include, for example, a step-up DC/DC converter, which steps up the input voltage to generate a voltage suitable for driving the motor 116.

The electrical device 118 is an air conditioner, a heater, or the like. The electrical device 118 is connected to the wires 130 to 136 via the four switches of the switch section 212. Of output terminals A to D of the four switches of the switch section 212 (terminals connected to the input terminals of the electrical device 118), the output terminal A of the switch connected to the wire 130 and the output terminal C of the switch connected to the wire 134 are connected to each other, and the output terminal B of the switch connected to the wire 132 and the output terminal D of the switch connected to the wire 136 are connected to each other. By having the electrical device 118 connected to the wires 130 to 136 via the switch section 212 in this manner, power is supplied from any single battery unit even if the connection states of the battery unit 102 and the battery unit 104 switch between a series connection and a parallel connection, as will be described later.

The in-vehicle charger 120 is a device used to charge the battery unit 102 and battery unit 104 from commercial power supplied to a home, for example. The in-vehicle charger 120 may include a charging device for wireless power transmission. The in-vehicle charger 120 is connected to the one terminal of the battery unit 102 and the other terminal of the battery unit 104 via the switches of the switch section 214. During charging by the in-vehicle charger 120 or wireless charging, the series-parallel connections of the battery units may be switched according to the breakdown voltages of the devices such as the DC/DC converters.

The switch 206 and the switch 208 are switches that are turned on when the battery unit 102 and battery unit 104 are charged by power supplied from a quick-charging device such as a charging stand or the like. The one terminal of the battery unit 102 is connected to one power line of the quick-charging device via the switch 206. The other terminal of the battery unit 104 is connected to another power line of the quick-charging device via the switch 208.

A switch control unit 122 is connected to the switches 200 to 208 and the switches in the switch sections 210 to 214, and controls the turning on and off of those switches. FIG. 1 does not illustrate wires connecting the switch control unit 122 to the switches.

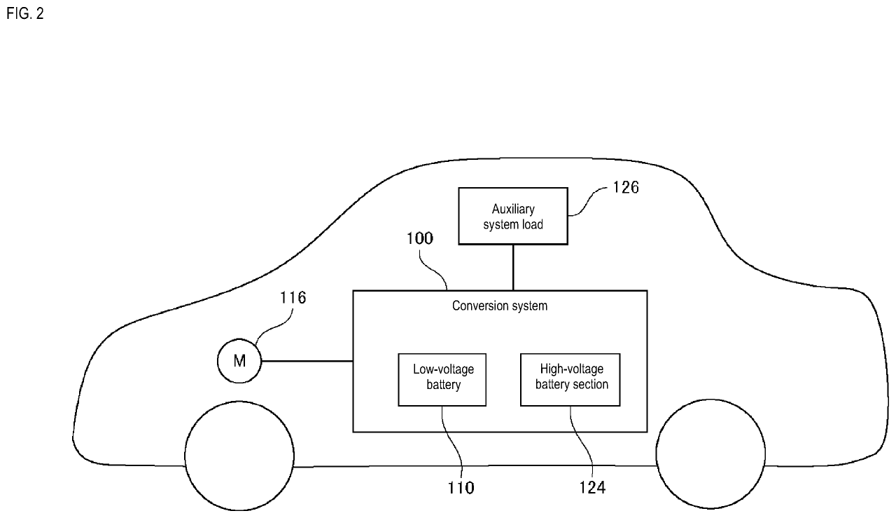

Referring to FIG. 2, the power conversion system 100 is installed in a vehicle such as a PHEV (Plug-in Hybrid Electric Vehicle) or an EV (Electric Vehicle). The power conversion system 100 charges the high-voltage battery section 124 and the low-voltage battery 110 with AC power supplied from an external AC power source. The power conversion system 100 supplies power from the high-voltage battery section 124 and the low-voltage battery 110 to the motor 116, an auxiliary system load 126, and the like while the vehicle is traveling. The auxiliary system load 126 is an auxiliary device necessary for operating the engine, the motor, and the like, and mainly includes a cell motor, an alternator, a radiator cooling fan, or the like. The auxiliary system load 126 may include the load 112 (lighting, a wiper drive unit, a navigation device, or the like) and the electrical device 118 (an air conditioner, a heater, or the like) as well.

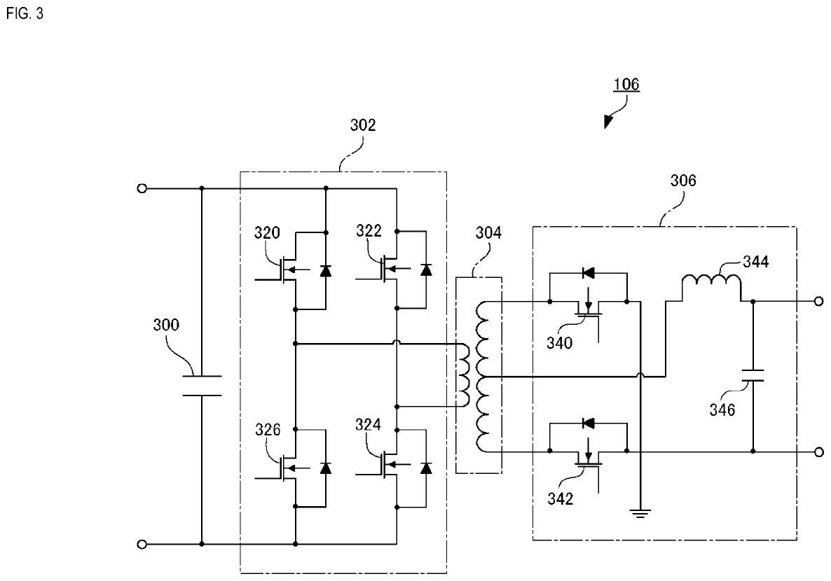

Referring to FIG. 3, the first DC/DC converter 106 corresponds to an example of a power conversion unit and a power conversion device, and includes a capacitor 300, a DC/AC converter 302, a transformer 304, and a rectifier 306. The second DC/DC converter 108 also corresponds to an example of a power conversion unit and a power conversion device, and has the same configuration as the first DC/DC converter 106. The DC/AC converter 302 includes switch elements 320, 322, 324 and 326 that constitute a full bridge circuit. An input terminal of the DC/AC converter 302 is connected to both terminals of the capacitor 300. An output terminal of the DC/AC converter 302 is connected to both terminals of a primary-side winding of the transformer 304. The DC/AC converter 302 converts DC voltage input from the capacitor 300 side into AC voltage and outputs the AC voltage to the primary-side winding of the transformer 304.

The rectifier 306 includes a switch element 340 and a switch element 342, an inductor 344, and a capacitor 346. An input side of the rectifier 306 is connected to both terminals of a secondary-side winding of the transformer 304. The secondary-side winding of the transformer 304 is a center-tapped coil. As a result, the rectifier 306 rectifies and smooths the AC voltage generated in the secondary-side winding of the transformer 304, and outputs the voltage as DC voltage. Accordingly, the first DC/DC converter 106 converts the high DC voltage input from the capacitor 300 side into a low DC voltage and supplies that voltage to the low-voltage battery 110.

Each switch element is constituted by, for example, a FET (Field Effect Transistor) having a freewheeling diode. For the purpose of protection from surge current and the like, the switch elements and freewheeling diodes are connected in parallel so that forward bias directions thereof are opposite from each other. The switch elements may be semiconductor devices aside from FETs, such as GaN-HEMTs (High Electron Mobility Transistors), for example.

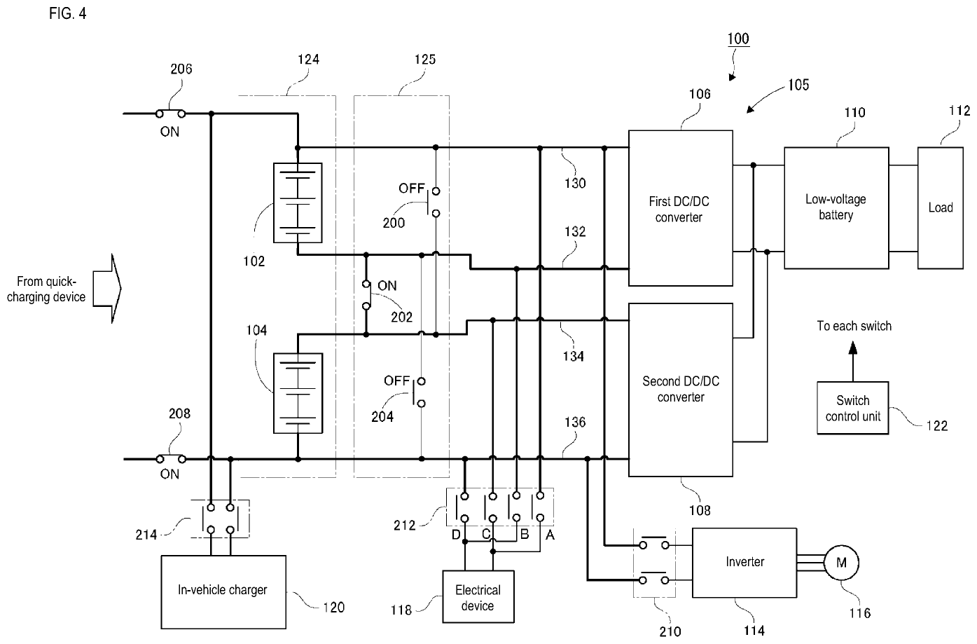

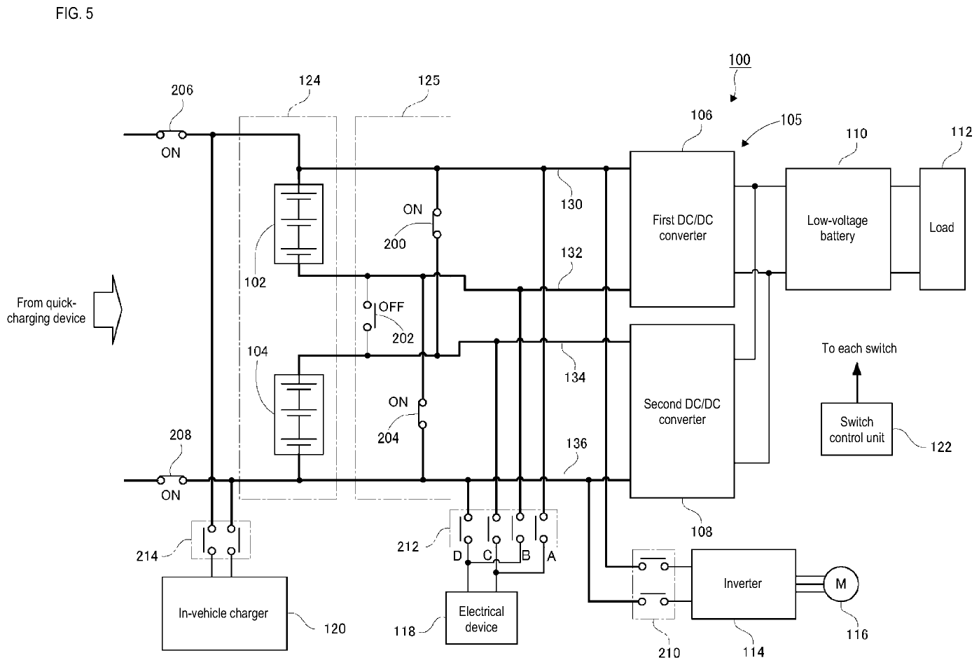

Functions of the power conversion system 100 will be described with reference to FIGS. 4 and 5. Referring to FIG. 4, consider a case where, for example, a quick-charging device supplies a voltage exceeding the voltage specifications of both the battery unit 102 and the battery unit 104 (e.g., 800 V), and charging is performed. In this case, the switch 202, the switch 206, and the switch 208 are turned on under the control of the switch control unit 122. The switch 200 and the switch 204, as well as the switch sections 210 to 214, are off. In FIG. 4, the lines to which power is supplied are indicated by bold lines. The battery unit 102 and the battery unit 104 are connected in series as a result. The first DC/DC converter 106 and the second DC/DC converter 108 are also connected in series. A connection node of the battery unit 102 and battery unit 104 connected in series is connected to a connection node of the first DC/DC converter 106 and the second DC/DC converter 108 connected in series. Accordingly, an 800 V charging voltage can be supplied from the quick-charging device to charge the battery unit 102 and battery unit 104 having 400 V specifications, and the low-voltage battery 110 can be charged with the output voltage from the first DC/DC converter 106 and the second DC/DC converter 108 having 400 V specifications.

Referring to FIG. 5, consider a case where, for example, the quick-charging device supplies a voltage suited to the voltage specifications of both the battery unit 102 and the battery unit 104 (e.g., 400 V), and charging is performed. In this case, the switch 200 and the switch 204, and the switch 206 and the switch 208, are turned on under the control of the switch control unit 122. The switch 202, as well as the switch sections 210 to 214, are off. In FIG. 5, the lines to which power is supplied are indicated by bold lines. The battery unit 102 and the battery unit 104 are connected in parallel as a result. The first DC/DC converter 106 and the second DC/DC converter 108 are also connected in parallel. Accordingly, a 400 V charging voltage can be supplied from the quick-charging device to charge the battery unit 102 and battery unit 104 having 400 V specifications, and the low-voltage battery 110 can be charged with the output voltage from the first DC/DC converter 106 and the second DC/DC converter 108 having 400 V specifications.

In this manner, the connection state of each battery unit in the plurality of battery units 102 and 104 can be switched to either a series connection state in which the battery units are connected to each other in series, or a parallel connection state in which the battery units are connected to each other in parallel. Furthermore, the first DC/DC converter 106 and the second DC/DC converter 108 can be switched to either a series connection state or a parallel connection state according to the connection state of the battery units 102 and 104. It is therefore possible to prevent voltage exceeding the respective breakdown voltages of the first DC/DC converter 106 and the second DC/DC converter 108 from being input thereto.

The battery unit 102 and the battery unit 104 may be configured to be connected in series as illustrated in FIG. 4 (with the first DC/DC converter 106 and the second DC/DC converter 108 also being connected in series) not only during charging, but also when the vehicle in which the battery units are installed is traveling. During travel, the switch 206 and the switch 208 are turned off, and the switches of the switch section 210 are turned on, under the control of the switch control unit 122. Although the output voltage of each of the battery unit 102 and the battery unit 104 is 400 V, the inverter 114 is supplied with 800 V, which is the voltage across the two terminals, of the series-connected battery unit 102 and the battery unit 104, that are not connected to each other (called a “series-connected voltage” hereinafter). In this case, the inverter 114 generates power to drive the motor 116 directly from the input 800 V, without going through the internal step-up DC/DC converter. In other words, a high voltage necessary for rotating the motor 116 at high speeds during high-speed travel can be supplied.

As described above, the connection node of the battery unit 102 and the battery unit 104 connected in series is connected to the connection node of the first DC/DC converter 106 and the second DC/DC converter 108 connected in series. Accordingly, the first DC/DC converter 106 can convert the 400 V supplied from the battery unit 102 to a low voltage, the second DC/DC converter 108 can convert the 400 V supplied from the battery unit 104 to a low voltage, and the low voltages can be supplied to the low-voltage battery 110. By turning on the switches of the switch section 212 as appropriate, the input terminals of the electrical device 118 can be supplied with the voltage across both terminals of the battery unit 102 (e.g., 400 V) or the voltage across both terminals of the battery unit 104 (e.g., 400 V). In other words, in a state where the high voltage (800 V) for the motor 116 is supplied from the high-voltage battery section 124, the first DC/DC converter 106 and the second DC/DC converter 108, as well as the electrical device 118, having the conventional specification (400 V) can be used as-is, and there is no need to put the first DC/DC converter 106 and the second DC/DC converter 108, as well as the electrical device 118, into the high voltage specification. Conventionally, depending on the motor output, a vehicle will also need to be provided with a step-up converter. However, by using the power conversion system 100, the high voltage for the motor 116 can be supplied from the high-voltage battery section 124, and there is therefore no need to provide a step-up converter.

Note that the battery unit 102 and the battery unit 104 may be configured to switch to a series connection in accordance with travel conditions of the vehicle in which those units are installed (vehicle speed, road speed limit, traffic jam conditions, and so on). For example, the battery unit 102 and the battery unit 104 may be configured to be connected in parallel when the vehicle in which those units are installed begins traveling, and switched to a series connection when the speed of the vehicle exceeds a predetermined speed. Additionally, the battery unit 102 and the battery unit 104 may be connected in parallel as illustrated in FIG. 5 when the vehicle in which those units are installed is traveling (with the first DC/DC converter 106 and the second DC/DC converter 108 also being connected in parallel). At this time, the inverter 114 is supplied with an output voltage of 400 V from each of the battery unit 102 and the battery unit 104. In this case, when the vehicle is traveling at a high speed, the inverter 114 steps the 400 V being input up to 800 V, via the internal step-up DC/DC converter, to generate the power for driving the motor 116.

Additionally, the first DC/DC converter 106 can convert the 400 V supplied from the battery unit 102 to a low voltage, the second DC/DC converter 108 can convert the 400 V supplied from the battery unit 104 to a low voltage, and the low voltages can be supplied to the low-voltage battery 110. By turning on the switches of the switch section 212 as appropriate, the input terminals of the electrical device 118 can be supplied with at least one of the voltage across both terminals of the battery unit 102 (e.g., 400 V) and the voltage across both terminals of the battery unit 104 (e.g., 400 V).

Thus in the configuration described thus far, the conversion device 105 includes the switching device 125 and the switch control unit 122 that controls the switching device 125. The switch control unit 122 corresponds to an example of a control unit. The switching device 125 is configured to switch the connection state of each of the plurality of battery units 102 and 104 between a series connection state and a parallel connection state, and switch the connection states of the first DC/DC converter 106 and the second DC/DC converter 108 (a plurality of power conversion units) with respect to the plurality of battery units 102 and 104. When the switch control unit 122 (the control unit) controls the switching device 125 to switch the connection state of each of the plurality of battery units 102 and 104 to the series connection state as illustrated in FIG. 4, the switching device 125 can be caused to operate so that the connection state of the first DC/DC converter 106 and the second DC/DC converter 108 is switched such that a voltage based on the voltage across both ends of at least one of the battery units in the plurality of battery units 102 and 104 is applied to each of the first DC/DC converter 106 and the second DC/DC converter 108 (the plurality of power conversion units). Specifically, the switch control unit 122 controls the switching device 125 so that the voltage based on the voltage across both ends of the one battery unit 102 is applied to the first DC/DC converter 106 and the voltage based on the voltage across both ends of the one battery unit 104 is applied to the second DC/DC converter 108.

Note that the breakdown voltage of each of the first DC/DC converter 106 and the second DC/DC converter 108 is a predetermined guaranteed operating voltage and is a predetermined fixed value. The voltage across both ends of both the battery units 102 and 104 when fully charged is lower than the breakdown voltage of each of the first DC/DC converter 106 and the second DC/DC converter 108. On the other hand, the voltage across both ends of all of the plurality of battery units 102 and 104 in a series connection state when each of the plurality of battery units 102 and 104 is fully charged is higher than the breakdown voltage of each of the first DC/DC converter 106 and the second DC/DC converter 108.

Furthermore, when the switch control unit 122 (the control unit) controls the switching device 125 to switch the connection state of each of the plurality of battery units 102 and 104 to the parallel connection state as illustrated in FIG. 5, the switching device 125 can be caused to operate so that the connection state of the first DC/DC converter 106 and the second DC/DC converter 108 is switched such that a voltage based on the voltage across both ends of the battery units 102 and 104 in the parallel connection state is applied to each of the first DC/DC converter 106 and the second DC/DC converter 108 (the plurality of power conversion units). This makes it possible for the first DC/DC converter 106 and the second DC/DC converter 108 to operate well when the plurality of battery units 102 and 104 are in the parallel connection state so as not to exceed the breakdown voltage of the power conversion units.

### First Variation

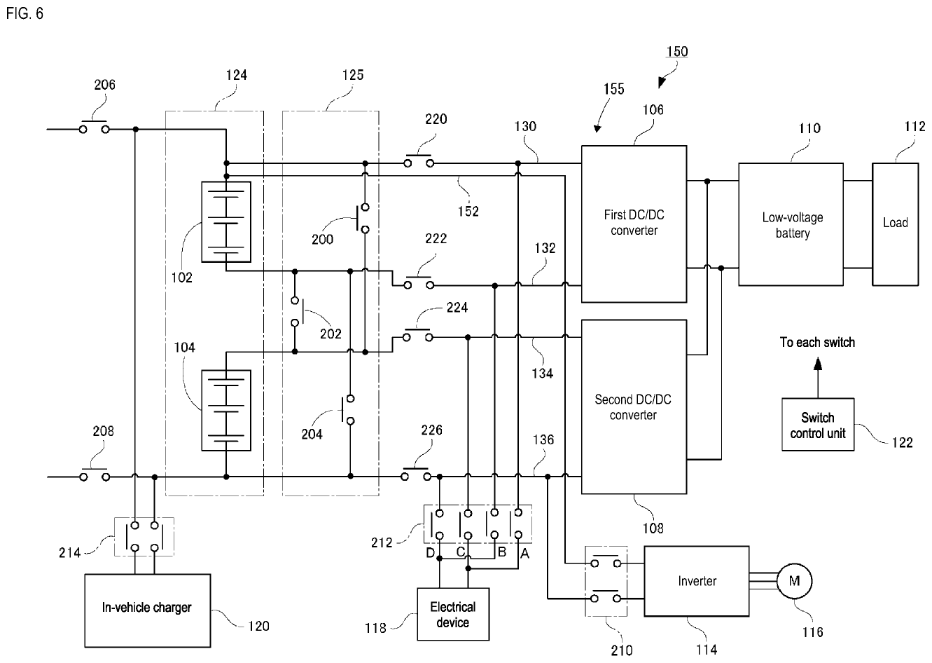

In the configuration illustrated in FIG. 1, additional switches may be provided. For example, the configuration illustrated in FIG. 1 may be modified as illustrated in FIG. 6. FIG. 6 illustrates a power conversion system 150 according to a first variation, and is achieved by adding switches 220 to 226 to the configuration illustrated in FIG. 1, and changing the wire connecting the wire 130 and the switches of the switch section 210 to a wire 152, which connects the one terminal of the battery unit 102 to the switches of the switch section 210. Because the rest of the configuration is the same as in FIG. 1, descriptions thereof will not be repeated, and will focus mainly on the differences.

A conversion device 155, which constitutes part of the conversion system 150, includes at least the first DC/DC converter 106 and the second DC/DC converter 108, the switching device 125, and the switch control unit 122.

The switch 220 is connected between the wire 130 and the switch 200, the switch 222 is connected between the wire 132 and one terminal of the switch 202, the switch 224 is connected between the wire 134 and another terminal of the switch 202, and the switch 226 is connected between the wire 136 and the switch 204. Accordingly, after the switches 200 to 204 are controlled to turn on and off by the switch control unit 122 and the battery unit 102 and the battery unit 104 have been put into a series connection (see FIG. 4) or a parallel connection (see FIG. 5), having the switch control unit 122 turn the switches 220 to 224 on sets the first DC/DC converter 106 and the second DC/DC converter 108 to an appropriate connection state according to the connection state of the battery unit 102 and the battery unit 104, as described above. Accordingly, an appropriate voltage (e.g., 400 V) is supplied to each of the first DC/DC converter 106 and the second DC/DC converter 108. When the switches of the switch section 210 are turned on by the switch control unit 122, the inverter 114 is supplied with a voltage based on the connection state of the battery unit 102 and the battery unit 104 (e.g., 800 V or 400 V). By having the switch control unit 122 turn the switches of the switch section 212 on and off as appropriate, the voltage of either one of the battery unit 102 and the battery unit 104 (e.g., 400 V), or the voltage from the battery unit 102 and the battery unit 104 connected in parallel (e.g., 400 V) is supplied to the electrical device 118.

### Second Variation

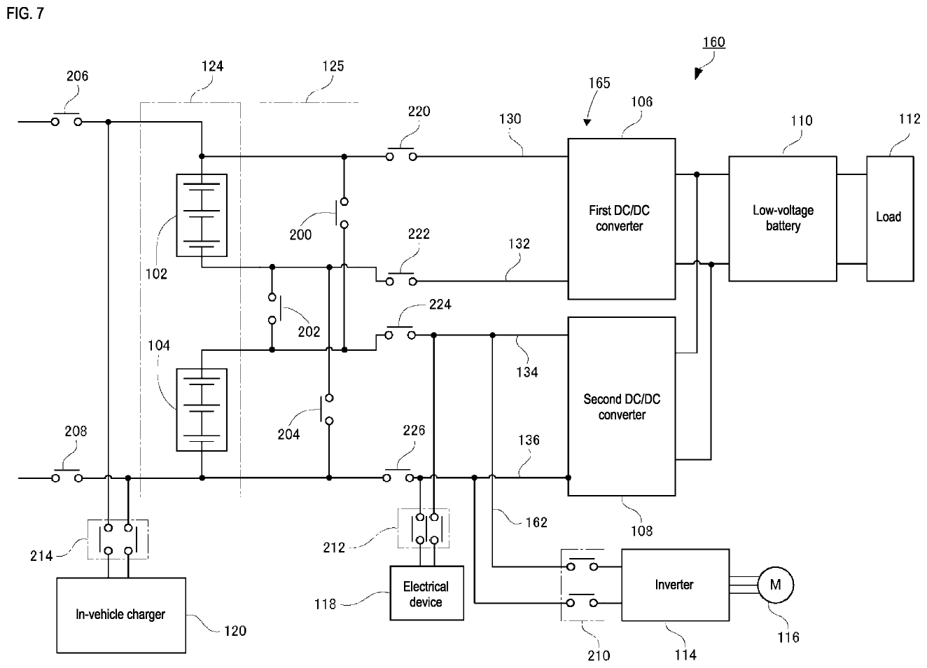

The configuration illustrated in FIG. 1 may be modified as illustrated in FIG. 7. FIG. 7 illustrates a power conversion system 160 according to a second variation, and is achieved by adding the switches 220 to 226 to the configuration illustrated in FIG. 1, and changing the wire connecting the wire 130 and the switches of the switch section 210 to a wire 162, which connects the wire 134 to the switches of the switch section 210. Because the rest of the configuration is the same as in FIG. 1, descriptions thereof will not be repeated, and will focus mainly on the differences.

A conversion device 165, which constitutes part of the conversion system 160, includes at least the first DC/DC converter 106 and the second DC/DC converter 108, the switching device 125, and the switch control unit 122 (the same as the switch control unit 122 in FIG. 1; not shown in FIG. 7).

The switches 220 to 226 are connected to the wires 130 to 136 in the same way as in FIG. 6. Accordingly, in the same manner as in FIG. 6, by having the switch control unit 122 control the switches 200 to 204 to turn on and off, and turning the switches 220 to 224 on, the first DC/DC converter 106 and the second DC/DC converter 108 are set to an appropriate connection state according to the connection state of the battery unit 102 and the battery unit 104. Accordingly, an appropriate voltage (e.g., 400 V) is supplied to each of the first DC/DC converter 106 and the second DC/DC converter 108. By having the switch control unit 122 turn the switches of the switch section 212 on and off as appropriate, the voltage of either one of the battery unit 102 and the battery unit 104 (e.g., 400 V), or the voltage from the battery unit 102 and the battery unit 104 connected in parallel (e.g., 400 V) is supplied to the electrical device 118. On the other hand, unlike in FIG. 6, when the switches of the switch section 210 are turned on by the switch control unit 122, the voltage from the battery unit 104 (e.g., 400 V), or the voltage from the battery unit 102 and the battery unit 104 connected in parallel (e.g., 400 V), is supplied to the inverter 114, according to the connection state of the battery unit 102 and the battery unit 104.

### Third Variation

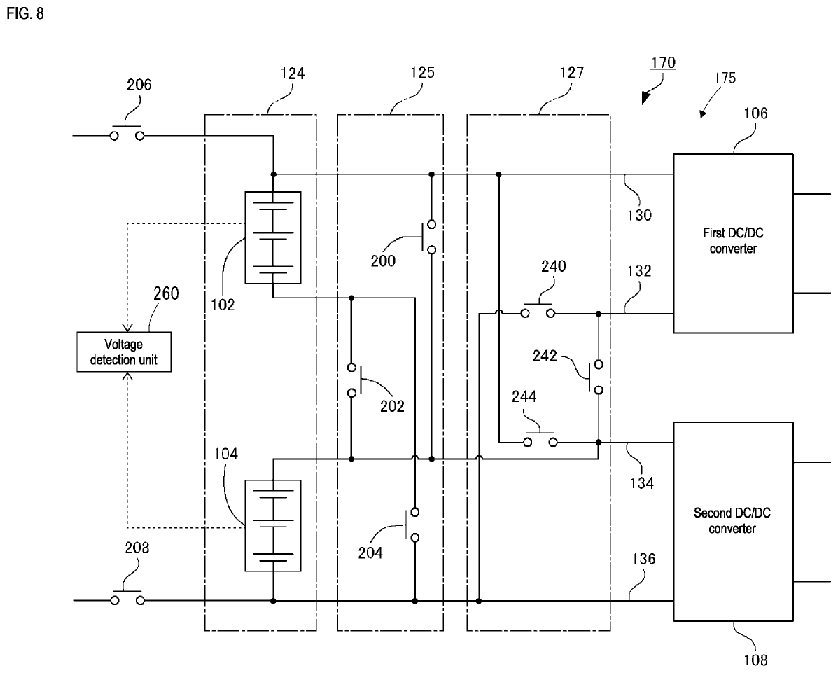

The configuration illustrated in FIG. 1 may be modified as illustrated in FIG. 8. FIG. 8 illustrates a power conversion system 170 according to a third variation, and is achieved by adding switches 240 to 244 to the configuration illustrated in FIG. 1, and changing the connection relationship of the wire 132 and the wire 134. Because the rest of the configuration, including items not illustrated in FIG. 8, is the same as in FIG. 1, descriptions thereof will not be repeated, and will focus mainly on the differences.

A conversion device 175, which constitutes part of the conversion system 170, includes at least the first DC/DC converter 106 and the second DC/DC converter 108, switching devices 125 and 127, and the switch control unit 122 (the same as the switch control unit 122 in FIG. 1; not shown in FIG. 8).

The switches 240 to 244 constitute the switching device 127, which is for switching the connection state of the first DC/DC converter 106 and the second DC/DC converter 108. One terminal (a terminal to which one voltage level (e.g., high voltage) is input) of each of the first DC/DC converter 106 and the second DC/DC converter 108 (corresponding to the wire 130 and the wire 134) is connected via the switch 244. Another terminal (a terminal to which a voltage level different from the one voltage level (e.g., low voltage) is input) of each of the first DC/DC converter 106 and the second DC/DC converter 108 (corresponding to the wire 132 and the wire 136) is connected via the switch 240. Another terminal of the first DC/DC converter 106 and the one terminal of the second DC/DC converter 108 (terminals to which mutually-different voltage levels are input) (corresponding to the wire 132 and the wire 134) are connected via the switch 242. Note that the one terminal of the second DC/DC converter 108 (corresponding to the wire 134) is connected to the one terminal of the battery unit 104.

By employing the configuration illustrated in FIG. 8, the connection state of the battery unit 102 and the battery unit 104, and the connection state of the first DC/DC converter 106 and the second DC/DC converter 108, can be changed independently. In other words, the connection state of the battery unit 102 and the battery unit 104 can be set to a series connection state by turning on the switch 202 with the switch 200 and the switch 204 turned off, and can be set to the parallel connection state by turning on the switch 200 and the switch 204 with the switch 202 turned off, as described above. The connection state of the first DC/DC converter 106 and the second DC/DC converter 108 can be set to a series connection state by turning on the switch 242 with the switch 240 and the switch 244 turned off, and can be set to the parallel connection state by turning on the switch 240 and the switch 244 with the switch 242 turned off. In other words, the first DC/DC converter 106 and the second DC/DC converter 108 can be put into the series connection state as well as the parallel connection state when the battery unit 102 and the battery unit 104 are connected in series. The first DC/DC converter 106 and the second DC/DC converter 108 can also be put into the series connection state and the parallel connection state when the battery unit 102 and the battery unit 104 are connected in parallel.

In this configuration, the switch control unit 122 (the control unit) controls the switching devices 125 and 127. The switching devices 125 and 127 are configured to switch the connection state of each of the plurality of battery units 102 and 104 between the series connection state and the parallel connection state, and to switch the connection state of each of the first DC/DC converter 106 and the second DC/DC converter 108 (the plurality of power conversion units) between the series connection state and the parallel connection state. The switching devices 125 and 127 are furthermore configured to switch the connection state of the first DC/DC converter 106 and the second DC/DC converter 108 with respect to the plurality of battery units 102 and 104.

When the switch control unit 122 (the control unit) controls the switching devices 125 and 127 to switch the connection state of each of the plurality of battery units 102 and 104 to the series connection state, the connection state of the first DC/DC converter 106 and the second DC/DC converter 108 can also be switched to the series connection state. In this case, the switch control unit 122 (the control unit) can cause the switching devices 125 and 127 to operate so that the connection state of the first DC/DC converter 106 and the second DC/DC converter 108 is switched such that a voltage based on the voltage across both ends of the plurality of battery units 102 and 104 in the series connection state is applied to both ends of the first DC/DC converter 106 and the second DC/DC converter 108 that have been put into the series connection state. In this case, a voltage obtained by dividing the voltage across both ends of all of the plurality of battery units 102 and 104 in the series connection state is applied to each of the first DC/DC converter 106 and the second DC/DC converter 108. Note that even when each of the plurality of battery units 102 and 104 is fully charged, the voltage (divided voltage) applied to each of the first DC/DC converter 106 and the second DC/DC converter 108 is adjusted to be no greater than the breakdown voltage of each of the first DC/DC converter 106 and the second DC/DC converter 108.

Furthermore, when the switch control unit 122 (the control unit) controls the switching devices 125 and 127 to switch the connection state of each of the plurality of battery units 102 and 104 to the parallel connection state, the switching devices 125 and 127 can be caused to operate so that the connection state of the first DC/DC converter 106 and the second DC/DC converter 108 (the first DC/DC converter 106 and the second DC/DC converter 108 connected in parallel) is switched such that a voltage based on the voltage across both ends of the plurality of battery units 102 and 104 in the parallel connection state is applied to each of the first DC/DC converter 106 and the second DC/DC converter 108 (the plurality of power conversion units).

Furthermore, when the switch control unit 122 (the control unit) controls the switching devices 125 and 127 to switch the connection state of each of the plurality of battery units 102 and 104 to the parallel connection state, the switching devices 125 and 127 can be caused to operate so that the connection state of the first DC/DC converter 106 and the second DC/DC converter 108 (the first DC/DC converter 106 and the second DC/DC converter 108 connected in series) is switched such that a voltage based on the voltage across both ends of the plurality of battery units 102 and 104 in the parallel connection state is applied to both ends of the first DC/DC converter 106 and the second DC/DC converter 108 (the plurality of power conversion units) in the series connection state.

Therefore, the connection state of the battery unit 102 and the battery unit 104, as well as the connection states of the first DC/DC converter 106 and the second DC/DC converter 108, can be changed according to the states (e.g., the output voltages) of the battery unit 102 and the battery unit 104. For example, when the series-connected voltage drops while the battery unit 102 and the battery unit 104 are connected in series, the first DC/DC converter 106 and the second DC/DC converter 108 may be switched from a series connection to a parallel connection. Additionally, when the output voltage has dropped while the battery unit 102 and the battery unit 104 are connected in parallel, the battery unit 102 and the battery unit 104 may be switched from a parallel connection to a series connection. This makes it possible to avoid a drop in the output voltage from the high-voltage battery section 124. The series-connected voltage from the battery unit 102 and the battery unit 104 may be calculated by monitoring the output voltage of each of the battery unit 102 and the battery unit 104 and adding those output voltages together, or by detecting the overall output voltage when the battery unit 102 and the battery unit 104 are in the series connection state.

Specifically, the following configuration can be employed.

In the example in FIG. 8, a voltage detection unit 260 is configured to be capable of detecting the output voltage of each of the battery unit 102 and the battery unit 104. Furthermore, the voltage detection unit 260 is configured to be capable of calculating “an output voltage when the battery unit 102 and the battery unit 104 are in the series connection state” (the overall voltage across both ends of the units in a series connection when the battery unit 102 and the battery unit 104 are in the series connection state) by adding together the respective output voltages of the battery unit 102 and the battery unit 104.

The switch control unit 122 (the control unit) monitors whether or not the stated output voltage detected by the voltage detection unit 260 has become less than or equal to a threshold, and when the output voltage has become less than or equal to the threshold, control the switching devices 125 and 127 such that the first DC/DC converter 106 and the second DC/DC converter 108 are connected in parallel with respect to both ends of the battery unit 102 and the battery unit 104 in the series connection state (both ends of all the units in a series connection) while keeping the connection state of the battery unit 102 and the battery unit 104 in the series connection state. In this case, a voltage based on the stated output voltage of the battery unit 102 and the battery unit 104 in the series connection state (the overall voltage across both ends of the units in a series connection) is applied to each of the first DC/DC converter 106 and the second DC/DC converter 108. Because the stated threshold is set to a lower value than the respective breakdown voltages of the first DC/DC converter 106 and the second DC/DC converter 108, the breakdown voltages will not be exceeded even if the voltages across both ends of the battery units 102 and 104 connected in series are applied to the respective converters.

### Fourth Variation

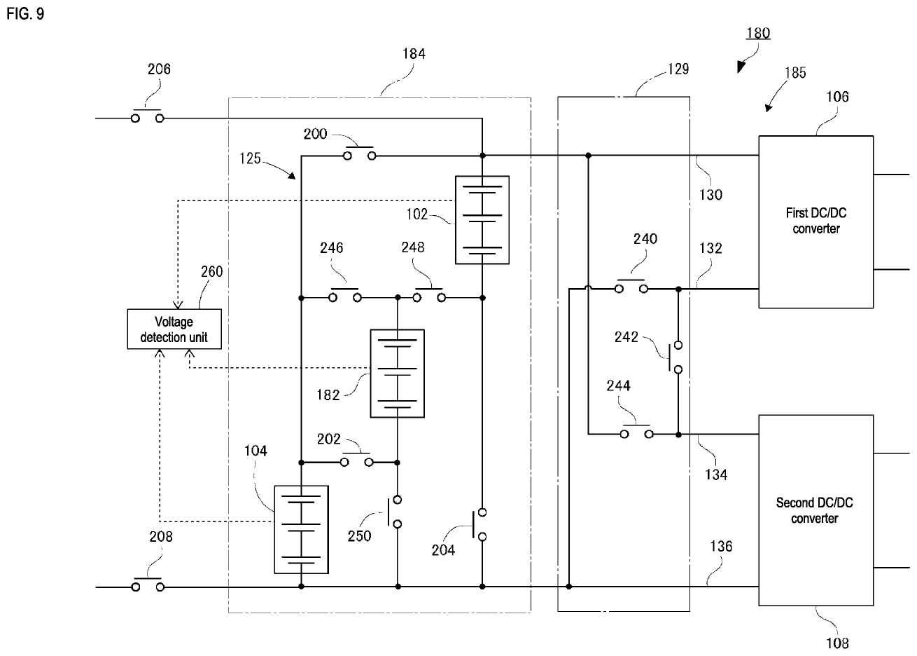

Although the foregoing has described a case where there are the same number of battery units as there are DC/DC converters, the configuration is not limited thereto. The number of battery units and the number of DC/DC converters may be different. For example, the configuration illustrated in FIG. 1 may be modified as illustrated in FIG. 9.

Referring to FIG. 9, a power conversion system 180 according to a fourth variation is achieved by adding a battery unit 182 and switches 240 to 250 to the configuration illustrated in FIG. 1, and changing the connection relationship of the wire 132 and the wire 134. The switches 200 to 204, which constitute the switching device 125 in FIG. 1, are included in a high-voltage battery section 184 illustrated in FIG. 9. Because the rest of the configuration, including items not illustrated in FIG. 9, is the same as in FIG. 1, descriptions thereof will not be repeated, and will focus mainly on the differences.

A conversion device 185, which constitutes part of the conversion system 180, includes at least the first DC/DC converter 106 and the second DC/DC converter 108, switching devices 125 and 129, and the switch control unit 122 (the same as the switch control unit 122 in FIG. 1; not shown in FIG. 9).

Like the battery unit 102 and the battery unit 104, the battery unit 182 is a unit constituted by a storage battery that can be charged and discharged. The battery unit 102, the battery unit 104, and the battery unit 182 are connected by the switches 200 to 204 and the switches 246 to 250, and constitute the high-voltage battery section 184, which is an example of a power supply device. Note that in the example in FIG. 9, the switching device 125 corresponds to the part of the high-voltage battery section 184 excluding the battery units 102, 104, and 182. One terminal (a terminal of the same polarity (positive)) of each of the battery unit 102 and the battery unit 104 is connected to the other via the switch 200. Another terminal (a terminal of the polarity opposite to the one terminal (negative)) of each of the battery unit 102 and the battery unit 104 is connected to the other via the switch 204. The other terminal of the battery unit 102 and one terminal of the battery unit 182 (terminals of different polarities) are connected to each other via the switch 248. The one terminal of the battery unit 182 and the one terminal of the battery unit 104 (terminals of the same polarity (positive)) are connected to each other via the switch 246. Another terminal of the battery unit 182 and another terminal of the battery unit 104 (terminals of the same polarity (negative)) are connected to each other via the switch 250. The other terminal of the battery unit 182 and the one terminal of the battery unit 104 (terminals of different polarities) are connected to each other via the switch 202.

The switches 240 to 244, which constitute the switching device 129, are connected to the first DC/DC converter 106 and the second DC/DC converter 108 in the same way as in the third variation (see FIG. 8). As with the third variation, by employing the configuration illustrated in FIG. 9, the connection state of the plurality of battery units (the battery unit 102, the battery unit 104, and the battery unit 182), and the connection state of the first DC/DC converter 106 and the second DC/DC converter 108, can be changed independently. In other words, the first DC/DC converter 106 and the second DC/DC converter 108 can be connected in series, as well as in parallel, with the battery unit 102, the battery unit 104, and the battery unit 182 connected in series. The first DC/DC converter 106 and the second DC/DC converter 108 can also be connected in series, as well as in parallel, with the battery unit 102, the battery unit 104, and the battery unit 182 connected in parallel.

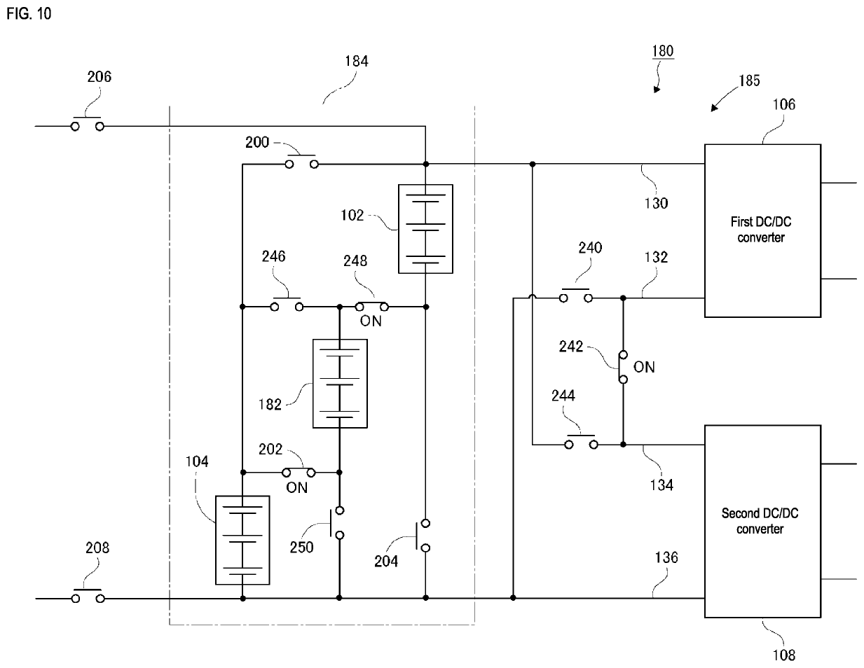

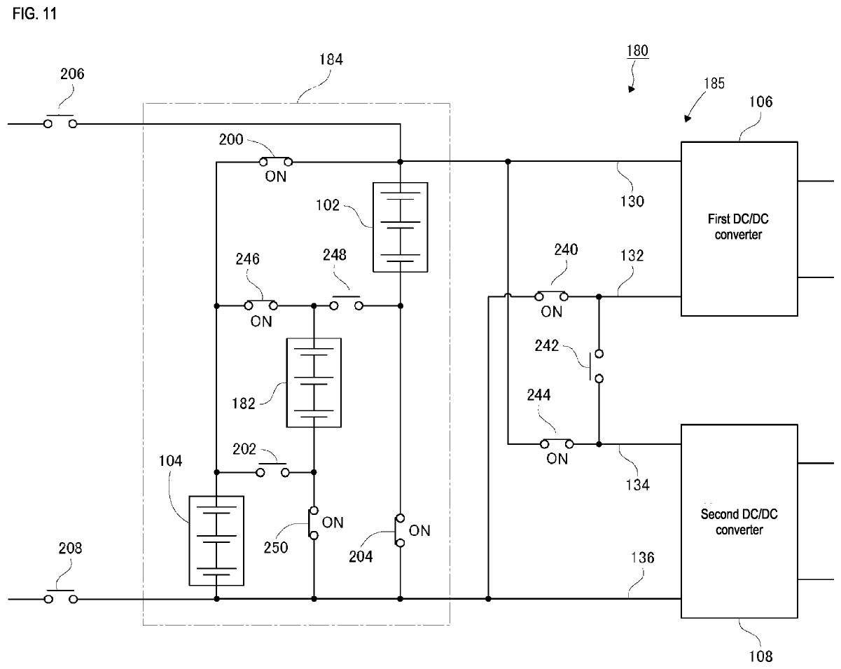

FIGS. 10 and 11 illustrate an example. Referring to FIG. 10, the switch 202, the switch 242, and the switch 248 are turned on under the control of the switch control unit 122 (see FIG. 1). All other switches are kept off. The battery unit 102, the battery unit 104, and the battery unit 182 are connected in series as a result. The first DC/DC converter 106 and the second DC/DC converter 108 are also connected in series. Accordingly, the voltage supplied from both terminals that are not connected to each other in the series connection of the battery unit 102, the battery unit 104, and the battery unit 182 (the series-connected voltage) can be shared by the first DC/DC converter 106 and the second DC/DC converter 108 connected in series, and the voltage input to each of the first DC/DC converter 106 and the second DC/DC converter 108 is lower than the series-connected voltage.

Referring to FIG. 11, the switch 200, the switch 204, the switch 240, the switch 244, the switch 246, and the switch 250 are turned on under the control of the switch control unit 122 (see FIG. 1). All other switches are kept off. The battery unit 102, the battery unit 104, and the battery unit 182 are connected in parallel as a result. The first DC/DC converter 106 and the second DC/DC converter 108 are also connected in parallel. Accordingly, the voltage supplied from each of the battery unit 102, the battery unit 104, and the battery unit 182 connected in parallel (e.g., 400 V) is supplied to each of the first DC/DC converter 106 and the second DC/DC converter 108 connected in parallel.

Accordingly, the connection state of the battery unit 102, the battery unit 104, and the battery unit 182, as well as the connection state of the first DC/DC converter 106 and the second DC/DC converter 108, can be changed in accordance with the states of the battery unit 102, the battery unit 104, and the battery unit 182 (e.g., the output voltages). For example, when the series-connected voltage has dropped in a state where the battery unit 102, the battery unit 104, and the battery unit 182 are connected in series (see FIG. 10), the first DC/DC converter 106 and the second DC/DC converter 108 may be switched from a series connection to a parallel connection. To switch the first DC/DC converter 106 and the second DC/DC converter 108 from a series connection to a parallel connection, the switch 242 is switched from on to off, and the switch 240 and switch 244 are switched from off to on (see FIG. 11). Additionally, when the output voltage drops while the battery unit 102, the battery unit 104, and the battery unit 182 are connected in parallel, the battery unit 102, the battery unit 104, and the battery unit 182 may be switched from a parallel connection to a series connection. The voltage in the series connection of the battery unit 102, the battery unit 104, and the battery unit 182 may be calculated by monitoring the output voltage of each of the battery unit 102, the battery unit 104, and the battery unit 182 and adding the output voltages together, or by detecting the overall output voltage when in a series connection state as illustrated in FIG. 10.

Even in the example illustrated in FIG. 9, the voltage detection unit 260 can be configured to be capable of detecting the output voltage of each of the battery units 102, 104, and 182. Furthermore, the voltage detection unit 260 may be configured to be capable of calculating the “output voltage when the battery units 102, 104, and 182 are in the series connection state” (the voltage across both ends of all the units in a series connection when the battery units 102, 104, and 182 are in the series connection state) by adding together the output voltages of the battery units 102, 104, and 182.

The switch control unit 122 (the control unit) monitors whether or not the stated output voltage detected by the voltage detection unit 260 has become less than or equal to a threshold, and when the output voltage has become less than or equal to the threshold, controls the switching devices 125 and 127 such that the first DC/DC converter 106 and the second DC/DC converter 108 are connected in parallel with respect to both ends of the battery units 102, 104, and 182 in the series connection state (both ends of all the units in a series connection) while keeping the connection state of the battery units 102, 104, and 182 in the series connection state. In this case, a voltage based on the stated output voltage of the battery units 102, 104, and 182 in the series connection state (the overall voltage across both ends of the units in a series connection) is applied to each of the first DC/DC converter 106 and the second DC/DC converter 108. Even in this example, because the stated threshold is set to a lower value than the respective breakdown voltages of the first DC/DC converter 106 and the second DC/DC converter 108, the breakdown voltages will not be exceeded even if the voltages across both ends of the battery units 102 and 104 connected in series are applied to the respective converters.

Although the foregoing has described a case where there are three battery units and two DC/DC converters, the configuration is not limited thereto. There may be four or more battery units, and three or more DC/DC converters. Providing switches that connect the terminals of the plurality of battery units to each other makes it possible to switch the connection state of the plurality of battery units between the series connection state and the parallel connection state. The same applies to the plurality of DC/DC converters. In other words, the connection state of the plurality of battery units and the connection state of the plurality of DC/DC converters can be switched between the series connection state and the parallel connection state independently.

Although the foregoing has described the circuits illustrated in FIG. 3 as specific examples of the first DC/DC converter 106 and the second DC/DC converter 108, the configuration is not limited thereto. The first DC/DC converter 106 and the second DC/DC converter 108 may be publicly-known DC/DC converters. Additionally, although the foregoing has described each battery unit, as well as the first DC/DC converter 106 and the second DC/DC converter 108, as having 400 V specifications, with a charging voltage of 800 V or 400 V being supplied from the quick-charging device, the configuration is not limited thereto. Each battery unit, as well as the first DC/DC converter 106 and the second DC/DC converter 108, may be specifications aside from 400 V. Furthermore, a charging voltage aside from 800 V or 400 V may be supplied from the quick-charging device.

Although the foregoing has described the power conversion system has being installed in a vehicle, the configuration is not limited thereto. The power conversion system may be used in applications aside from vehicles.

While the present invention has been described through descriptions of embodiments, the foregoing embodiments are examples, and the present invention is not intended to be limited only to the foregoing embodiments. The scope of the present invention is defined by the respective patent claims in light of the detailed description of the invention, and includes all modifications made within a meaning and scope equivalent to the wording given therein.

1. A conversion device that converts power supplied from a power supply device including a plurality of battery units, the conversion device comprising:
a plurality of power conversion units,
wherein each of the plurality of power conversion units is connected to the plurality of battery units such that a voltage within a range of a breakdown voltage of the power conversion units is input.

2. The conversion device according to claim 1,
wherein a connection state of each of the battery units in the plurality of battery units is switched between a series connection state and a parallel connection state, and
the plurality of power conversion units can be switched to one of a series connection state, in which the power conversion units are connected to each other in series, and a parallel connection state, in which the power conversion units are connected to each other in parallel, in accordance with the connection state of each of the battery units in the plurality of battery units.

3. The conversion device according to claim 1, wherein each of the plurality of battery units has an output rating lower than the breakdown voltage of any of the plurality of power conversion units, and
each of the plurality of power conversion units is connected to corresponding ones of the plurality of battery units.

4. The conversion device according to claim 1, further comprising:
a switching device configured to switch the connection states of the plurality of battery units.

5. The conversion device according to claim 4, further comprising:
a control unit configured to control the switching device,
wherein the switching device is configured to switch the connection state of each of the plurality of battery units between the series connection state and the parallel connection state, and switch the connection state of the plurality of power conversion units with respect to the plurality of battery units, and
when controlling the switching device to switch the connection state of each of the plurality of battery units to the series connection state, the control unit is configured to cause the switching device to perform an operation of switching the connection state of the plurality of power conversion units such that a voltage based on a voltage across both ends of at least one of the battery units among the plurality of battery units is applied to at least one of the plurality of power conversion units.

6. The conversion device according to claim 4, further comprising:
a control unit configured to control the switching device,
wherein the switching device is configured to switch the connection state of each of the plurality of battery units between the series connection state and the parallel connection state, switch the connection state of each of the plurality of power conversion units between the series connection state and the parallel connection state, and switch the connection state of the plurality of power conversion units with respect to the plurality of battery units, and
when controlling the switching device to switch the connection state of each of the plurality of battery units to the series connection state, the control unit is configured to cause the switching device to perform an operation of switching the connection state of each of the plurality of power conversion units to the series connection state, and switching the connection state of the plurality of power conversion units such that a voltage based on a voltage across both ends of the plurality of battery units put into the series connection state is applied to both ends of the plurality of power conversion units put into the series connection state.

7. The conversion device according to claim 5, wherein when controlling the switching device to switch the connection state of each of the plurality of battery units to the parallel connection state, the control unit is configured to cause the switching device to perform an operation of switching the connection state of the plurality of power conversion units such that a voltage based on a voltage across both ends of the battery units put into the parallel connection state is applied to at least one of the plurality of power conversion units.

8. The conversion device according to claim 1, wherein when controlling the switching device to switch the connection state of each of the plurality of battery units to the parallel connection state, the control unit is configured to cause the switching device to perform an operation of switching the connection state of the plurality of power conversion units such that a voltage based on a voltage across both ends of the battery units put into the parallel connection state is applied to both ends of the plurality of power conversion units put into the series connection state.

9. The conversion device according to claim 4, further comprising:
a control unit configured to control the switching device; and
a voltage detection unit configured to detect a voltage,
wherein the voltage detection unit detects an output voltage of the plurality of battery units when the plurality of battery units are in the series connection state,
the switching device is configured to switch the connection state of each of the plurality of battery units between the series connection state and the parallel connection state, and switch the connection state of the plurality of power conversion units with respect to the plurality of battery units, and
the control unit is configured to cause the switching device to perform an operation of switching the connection state of each of the plurality of battery units to the series connection state, and switching the connection state of the plurality of power conversion units such that a voltage based on the output voltage of the plurality of battery units put into the series connection state is applied to at least one of the plurality of power conversion units, under a condition that the output voltage detected by the voltage detection unit is less than or equal to a threshold.

10. A conversion system, comprising:
a power supply device including a plurality of battery units; and
the conversion device according to any one of claim 1 to claim 9, the conversion device being configured to convert power supplied from the power supply device.

11. The conversion system according to claim 10, further comprising:
an inverter configured to be supplied with the power from the power supply device; and
a motor configured to be supplied with power via the inverter.

12. A switching device that, in a system including a power supply device having a plurality of battery units and a plurality of power conversion devices that convert power supplied from the plurality of battery units, switches a connection state of the plurality of power conversion devices,
wherein each of the plurality of power conversion devices is connected to the plurality of battery units such that a voltage within a range of a breakdown voltage of the power conversion devices is input, and
the switching device comprises a plurality of switches that, by switching, in accordance with a predetermined condition being satisfied, a connection state of the plurality of battery units to one of a series connection state in which the battery units are connected to each other in series and a parallel connection state in which the battery units are connected to each other in parallel, switch a connection state of the plurality of power conversion devices to one of the series connection state and the parallel connection state.

13. The switching device according to claim 12, wherein the switching device is installed, along with the system, in a vehicle, and
the predetermined condition includes a condition pertaining to a travel condition.

14. The switching device according to claim 12, wherein at least one of the plurality of switches includes a semiconductor relay.

15. A vehicle, comprising:
the conversion system according to claim 10; and
a load to which power converted by the conversion system is supplied.

16. A control method that, in a system including a power supply device having a plurality of battery units and a plurality of power conversion devices that convert power supplied from the plurality of battery units, controls switching of a connection state of the plurality of power conversion devices,
wherein each of the plurality of power conversion devices is connected to the plurality of battery units such that a voltage within a range of a breakdown voltage of the power conversion devices is input, and
the control method comprises a step of switching, in accordance with a predetermined condition being satisfied, a connection state of the plurality of battery units to one of a series connection state in which the battery units are connected to each other in series and a parallel connection state in which the battery units are connected to each other in parallel, to switch a connection state of the plurality of power conversion devices to one of the series connection state and the parallel connection state.
